(19) United States
(12) Patent Application Publication
(10) Pub. No.: US 2011/0224317 A1
(43) Pub. Date: Sep. 15, 2011

(54) SPRAY FOAMS WITH FINE PARTICULATE BLOWING AGENT

(75) Inventor: Robert J. O'Leary, Newark, OH (US)

(73) Assignee: OWENS CORNING INTELLECTUAL CAPITAL, LLC, Toledo, OH (US)

(21) Appl. No.: 13/113,785

(22) Filed: May 23, 2011

Related U.S. Application Data
(63) Continuation-in-part of application No. 12/688,947, filed on Jan. 18, 2010.
(60) Provisional application No. 61/145,740, filed on Jan. 19, 2009.

(51) Int. Cl. C08J 9/08

(52) U.S. Cl. 521/70

(57) ABSTRACT

Latex foams for filling cavities and crevices and for forming foamed products are provided. The latex foam includes a functionalized latex, a crosslinking agent and a blowing agent package, and optionally a non-functionalized latex. The foamable compositions may be two-part, having an A-side and a B-side to keep reactants separate until use. The blowing agent package may be the combination of two or more chemicals, such as acid and base, that when mixed together form a gas. In two-part compositions, the acid and base preferably are in separate sides to prevent premature gassing; in alternative one-part compositions, the spray latex foam may include a functionalized latex, a crosslinking agent, and an encapsulated dry acid and dry base. The encapsulating agent may be a protective, non-reactive shell that can be broken or melted at the time of application. The acid and/or base are preferably dry powder particulates, for example milled bicarbonate having a median particle diameter of from about 0.5 to about 40 microns, e.g. from about 2 to about 40 microns or from about 0.5 to about 5 microns.

### CROSS-REFERENCE TO RELATED APPLICATIONS

This application is a continuation in part of prior application Ser. No. 12/688,947 filed Jan. 18, 2010, pending, which is a non-provisional of application 61/145,740 filed Jan. 19, 2009, expired. In addition, this application is related to prior patent applications:
U.S. application No. 61/421,680 filed Dec. 10, 2010, pending;
U.S. application Ser. No. 12/875,640 filed Sep. 3, 2010, pending;
US patent publication 2010-0189908 filed Jan. 18, 2010, pending, which is a non-provisional of application 61/182,345 filed May 29, 2009, expired;
US patent publication 2009-0111902 filed Oct. 25, 2007, pending;
US patent publications 2008-0161430, 2008-0161431, 2008-0161432, and 2008-0161433, all filed Aug. 16, 2007 and pending;
US patent publication 2008-0160203, filed Dec. 29, 2006, pending.
   Each of the US patent publications and US patent applications mentioned above is incorporated herein in its entirety.

### BACKGROUND OF THE INVENTION

Spray foams have found widespread utility in the fields of insulation and structural reinforcement. For example, spray foams are commonly used to insulate or impart structural strength to items such as automobiles, hot tubs, refrigerators, boats, and building structures. In addition, spray foams are used in applications such as cushioning for furniture and bedding, padding for underlying carpets, acoustic materials, textile laminates, and energy absorbing materials. Currently, spray foams, especially those used as insulators or sealants for home walls, are polyurethane spray foams.

Polyurethane spray foams and their methods of manufacture are well known. Typically, polyurethane spray foams are formed from two separate components, commonly referred to as an “A” side and a “B” side, that react when they come into contact with each other. The first component, or the “A” side, contains an isocyanate such as a di- or poly-isocyanate that has a high percent of reactive isocyanate groups (—N═C═O) on the molecule. The second component, or “B” side, contains nucleophilic reagents such as polyols that include two or more hydroxyl groups, silicone-based surfactants, blowing agents, catalysts, and/or other auxiliary agents. The nucleophilic reagents are generally polyols, primary and secondary polyamines, and/or water. Preferably, mixtures of diols and triols are used to achieve the desired foaming properties. The overall polyol hydroxyl number is designed to achieve a 1:1 ratio of first component to second component (A:B).

The two components are typically delivered through separate lines into a spray gun such as an impingement-type spray gun. The first and second components are pumped through small orifices at high pressure to form separate streams of the individual components. The streams of the first and second components intersect and mix with each other within the gun and begin to react. The heat of the reaction causes the temperature of the reactants in the first and second components to increase. This rise in temperature causes the blowing agent located in the second component (the “B” side) to vaporize and form a foam mixture. As the mixture leaves the gun, the mixture contacts a surface, sticks to it, and continues to react until the isocyanate groups have completely reacted. The resulting resistance to heat transfer, or R-value, may be from 3.5 to 8 per inch.

There are several problems associated with conventional polyurethane spray foams. For example, although sealing a building with such polyurethane spray foams reduces drafts and keeps conditioned air inside and external air outside of a building, there is a reduction in the ability of moisture to penetrate the building. As a result, the levels of moisture and air pollutants rise in these tightly sealed buildings that no longer permit moisture penetration into the building.

Another problem associated with conventional polyurethane spray foams is that the first component (the “A” side) contains high levels of methylene-diphenyl-di-isocyanate (MDI) monomers. When the foam reactants are sprayed, the MDI monomers form droplets that may be inhaled by workers installing the foam if stringent safety precautions are not followed. Even a brief exposure to isocyanate monomers may cause difficulty in breathing, skin irritation, blistering and/or irritation to the nose, throat, and lungs. Extended exposure of these monomers can lead to a sensitization of the airways, which may result in an asthmatic-like reaction and possibly death.

An additional problem with such conventional polyurethane spray foams is that residual polymeric methylene-diphenyl-di-isocyanate (PMDI) that is not used is considered to be a hazardous waste. PMDI typically has an NCO of about 20%. In addition, PMDI can remain in a liquid state in the environment for years. Therefore, specific procedures must be followed to ensure that the PMDI waste product is properly and safely disposed of in a licensed land fill. Such precautions are both costly and time consuming.

In this regard, attempts have been made to reduce or eliminate the presence of isocyanate and/or isocyanate emission by spray foams into the atmosphere. Examples of such attempts are set forth below.

U.S. Patent Publication No. 2006/0047010 to O'Leary teaches a spray polyurethane foam that is formed by reacting an isocyanate prepolymer composition with an isocyanate reactive composition that is encapsulated in a long-chain, inert polymer composition. The isocyanate prepolymer composition contains less than about 1 wt % free isocyanate monomers, a blowing agent, and a surfactant. The isocyanate reactive composition contains a polyol or a mixture of polyols that will react with the isocyanate groups and a catalyst. During application, the spray gun heats the polymer matrix, which releases the polyols and catalyst from the encapsulating material. The polyols subsequently react with the isocyanate prepolymer to form a polyurethane foam.

U.S. Patent Publication Nos. 2008/0161430; 2008/0161431; 2008/0161433; 2008/0161432; 2009/0111902; and 2010/0175810 to Korwin-Edson et al. disclose a room temperature crosslinked latex foam, such as for filling cavities and crevices. The foam contains an A-side or component that includes a functionalized latex and a B-side or component that contains a crosslinking agent, and optionally, a non-reactive resin (e.g., a non-functionalized latex). Either or both the A-side or the B-side may contain a blowing agent package. Alternatively, the A-side and the B-side may each contain a component such as an acid and a base that together form a blowing agent package. A plasticizer, a surfactant, a thickener, and/or a co-solvent may optionally be included in either the A- and/or B-side. U.S. Patent Publication 2010/0175810 discloses a particular technique for applications of spray foams containing polyacrylic acid as well as having a solid blowing agent comprising sodium bicarbonate having a mean particle size of 2-40 microns, preferably about 11 microns.

U.S. Patent Publication No. 2007/0290074 to Dansizen et al. teaches a method for the rapid insulation of expanses. The method utilizes a two-part spray foam system that may be applied at low temperatures; however, the chemicals must reach 70-85° F. for proper performance, and the system utilizes heated spraying hoses to heat the material for application at such low temperatures.

U.S. Pat. No. 7,053,131 to Ko, et al. discloses absorbent articles that include super critical fluid treated foams. In particular, super critical carbon dioxide is used to generate foams that assertedly have improved physical and interfacial properties.

U.S. Pat. No. 6,753,355 to Stollmaier, et al. discloses a composition for preparing a latex foam that includes a latex and a polynitrilic oxide (e.g., 2,4,6-triethylbenzene-1,3-dinitrile oxide) or a latex and an epoxy silane. The latex may be carboxylated. It is asserted that the composition is stable for at least twelve months and that the one-part coating systems can be cured at room temperature without the release of by-products.

U.S. Pat. No. 6,414,044 to Taylor teaches foamed caulk and sealant compositions that include a latex emulsion and a liquid gaseous propellant component. The foamed compositions do not contain a gaseous coagulating component.

U.S. Pat. No. 6,071,580 to Bland, et al. discloses an absorbent, extruded thermoplastic foam made with blowing agents that include carbon dioxide. The foam is allegedly capable of absorbing liquid at about 50 percent or more of its theoretical volume capacity.

U.S. Pat. No. 5,585,412 to Natoli, et al. discloses a process for preparing flexible CFC-free polyurethane foams that uses an encapsulated blowing agent. The process provides a polyurethane foam having a desired density that avoids the use of chlorofluorocarbons or other volatile organic blowing agents. The encapsulated blowing agent assertedly supplements the primary blowing action provided by water in the manufacture of water-blown polyurethane foam and facilitates in the production of foam having the desired density.

U.S. Pat. No. 4,306,548 to Cogliano discloses lightweight foamed porous casts. To manufacture the casts, expanded non-porous polystyrene foam beads or other shapes are coated with a layer of neoprene, natural rubber, or other latex. The coated polystyrene is then encased in a porous envelope, and the envelope is applied to a broken limb. Additional coated polystyrene is added over the envelope and a gaseous coagulant is added to gel the latex, which causes the polystyrene beads to adhere to each other and produce a unified, rigid structure.

Despite these attempts to reduce or eliminate the use of isocyanate in spray foams and/or reduce isocyanate emission into the air, there remains a need in the art for a spray foam that is non-toxic and environmentally friendly.

### SUMMARY OF THE INVENTION

The invention relates to improved one-part and two-part foamable compositions and methods of using them to form foamed products. The improved foams have a number of advantages described herein. Accordingly, in a first embodiment the invention provides a two-part foamable composition comprising:

a first component including at least one functionalized resin selected from a functionalized water-dispersible resin and a functionalized water-soluble resin; and

a second component including a crosslinking agent that crosslinks at or about room temperature, and

a blowing agent package, wherein the blowing agent package consists essentially of an acid and a base that, upon combination, react to generate a gas, and wherein one of said acid and base is included in the first component while the other of said acid and base is included in the second component; and wherein the base is a dry powder having a mean particle size of from about 0.5 to about 40 microns.

In an alternative embodiment, the invention provides a one-part foamable composition comprising:

at least one functionalized resin selected from a functionalized water-dispersible resin and a functionalized water-soluble resin;

a crosslinking agent that crosslinks at or about room temperature; and

a blowing agent package, said blowing agent package comprising an acid and a base that, upon combination, react to form a gas, said base being a dry particulate having a median particle size of from about 0.5 to about 50 microns;

wherein said crosslinking agent and at least one of said acid and said base are encapsulated.

In either embodiment, the composition may further comprise a non-functionalized resin, and in either embodiment the functionalized resin may contain from about 1% to about 50% by weight of reactive functional groups, such as for example carboxyl groups, and may comprise one or more members selected from a functionalized latex and an acrylic solution. In either embodiment, the crosslinking agent may be selected from aziridines, multifunctional carbodiimides, polyfunctional aziridines, melamine formaldehyde, polysiloxanes and multifunctional epoxies, more typically from aziridines, polyfunctional aziridines, polysiloxanes and multifunctional epoxies, optionally from aziridines or polyfunctional aziridines.

In either embodiment, the blowing agent may be formed of an acid and a base that generate a gas when mixed. In some embodiments, the gas may be hydrogen, nitrogen, oxygen, or carbon dioxide; although a stable, non-explosive and relatively inert gas like carbon dioxide is especially useful. In two-part embodiments, when the first component contains the acid, the second component contains the base, and vice-versa. The acid may be a dry acid powder with or without chemically bound water. Non-exclusive examples of suitable acids include citric acid, oxalic acid, tartaric acid, succinic acid, fumaric acid, adipic acid, maleic acid, malonic acid, glutaric acid, phthalic acid, metaphosphoric acid, or salts that are convertible into an acid that is an alkali metal salt of citric acid, tartaric acid, succinic acid, fumaric acid, adipic acid, maleic acid, oxalic acid, malonic acid, glutaric acid, phthalic acid, metaphosphoric acid, or a mixture thereof. In at least one embodiment, the acid is polyacrylic acid, which is a polymer of the general formula:

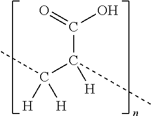

and having a molecular weight ranging from about 2,000 to about 250,000.

When present, preferably the base contains anionic carbonate or hydrogen carbonate (“bicarbonate”) and an alkali metal, an alkaline earth metal or a transition metal as a cation. Examples of bases suitable for use in the practice of this invention include calcium carbonate, barium carbonate, strontium carbonate, magnesium carbonate, lithium carbonate, sodium carbonate, potassium carbonate, rubidium carbonate, cesium carbonate, calcium hydrogen carbonate, barium hydrogen carbonate, strontium hydrogen carbonate, magnesium hydrogen carbonate, lithium hydrogen carbonate, sodium hydrogen carbonate, potassium hydrogen carbonate, rubidium hydrogen carbonate, cesium hydrogen carbonate, and bicarbonates and combinations thereof. In preferred embodiments, the base is a carbonate or bicarbonate such as sodium bicarbonate.

In some embodiments, the bicarbonate has a mean particle size from about 2 to about 250 microns, and more preferably a mean particle size from about 2 to about 40 microns. In at least one exemplary embodiment, the sodium bicarbonate is about 11 microns. In other exemplary embodiments, the bicarbonate has a median particle size from about 0.5 to about 5 microns, and more preferably a median particle size from about 0.75 to about 2 microns.

It is an advantage of the present invention that the inventive foams do not contain the harmful chemicals found in conventional polyurethane spray foams, such as, for example, MDI monomers. As a result, the foams of the present invention do not contain harmful vapors that may cause skin or lung sensitization or generate toxic waste. Additionally, the foams do not emit harmful vapors into the air when the foam is sprayed, such as when filling cavities to seal and/or insulate a building. The inventive foams are safe for workers to install and, therefore, can be used both in the house renovation market and in occupied houses. Additionally, because there are no harmful chemicals in the inventive foams, the foams can be safely disposed without having to follow any stringent hazardous waste disposal precautions.

It is another advantage of the present invention that the foams may be applied using existing spray equipment designed for conventional two-part spray polyurethane foam systems without clogging the spray equipment. Thus, the application gun is capable of repeated use without clogging and the resulting necessary cleaning when the foams of the present invention are utilized.

It is also an advantage of the present invention that the components of the one-part foam compositions in which the crosslinking agent and base or the acid and base are encapsulated may be mixed and stored in one container without significant reaction until the composition is used.

It is yet another advantage of the present invention that the polyacrylic acid reacts with the crosslinking agent and becomes integrated with the structure of the foam.

It is another feature of the present invention that polyacrylic acid reacts with a base such as sodium bicarbonate to generate CO₂ gas.

It is yet another feature of the present invention that the dry acid and dry base forming the blowing agent can be encapsulated in a single encapsulant or, alternatively, in separate encapsulating materials.

It is yet another feature of the present invention that blowing agent or components forming the blowing agent may be encapsulated a wax, a gelatin, a low melting, semi-crystalline, super-cooled polymer such as polyethylene oxide or polyethylene glycol, or a polymer or acrylic that can be broken at the time of the application of the foam.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

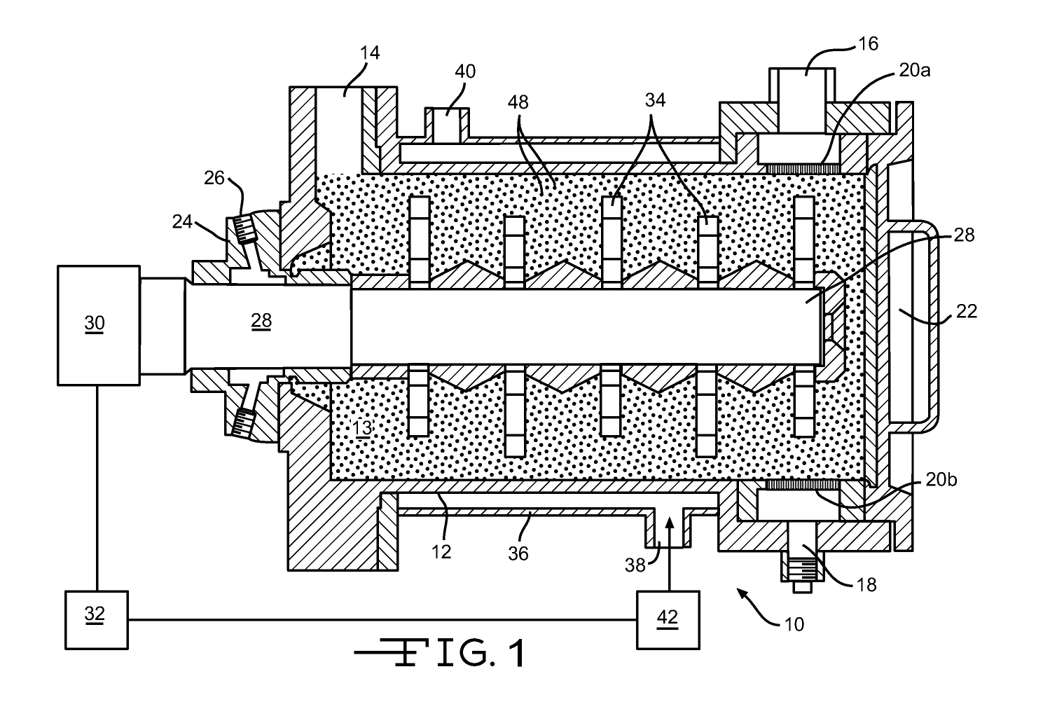

The advantages of this invention will be apparent upon consideration of the following detailed disclosure of the invention, especially when taken in conjunction with the accompanying drawings wherein FIG. 1 is a schematic representation of a media milling device.

### DETAILED DESCRIPTION OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references. The terms “foamable composition”, and “foam composition” may be interchangeably used in this application. In addition, the terms “encapsulant” and “encapsulating material” may be used interchangeably herein. Further, the terms “reaction mixture” and “foamable reaction mixture” may be used interchangeably within this application.

The term “R-value” is the commercial unit used to measure the effectiveness of thermal insulation and is the reciprocal of its thermal conductance which, for “slab” materials having substantially parallel faces, is defined as the rate of flow of thermal energy (BTU/hr or Watt) per unit area (square foot=ft² or square meter=m²) per degree of temperature difference (Fahrenheit or Kelvin) across the thickness of the slab material (inches or meters). Inconsistencies in the literature sometimes confuse the intrinsic thermal properties resistivity, r, (and conductivity, k), with the total material properties resistance, R, (and conductance, C), the difference being that the intrinsic properties are defined as being per unit thickness, whereas resistance and conductance (often modified by “total”) are dependent on the thickness of the material, which may or may not be 1 unit. This confusion, compounded by multiple measurement systems, produces an array of complex and confusing units the most common of which are:

| | English | |
|---|---|---|
| | (inch-pound) | Metric/SI units |
| Intrinsic resistivity, r (conductivity, k, is reciprocal) | $\frac{hr * {ft}^{2} * ° F .}{BTU * in}$ | $\frac{K * m}{W}$ |
| Total material resistance, R (conductance, C, is reciprocal) | $\frac{hr * {ft}^{2} * ° F .}{BTU}$ | $\frac{K * {m}^{2}}{W}$ |

For ease of comparisons of materials of differing thicknesses, the building industry sometimes reports thermal resistance (or conductance) per unit thickness (e.g. per inch) effectively converting it to thermal resistivity (conductivity), but retains the traditional symbol, R or R-value.

A “latex” refers to a dispersion of a solid polymer in an aqueous medium. Generally the polymer has a T_{g} less than about 20° C., usually lower than about 10° C., and typically the particles of polymer are of a size that makes a latex a colloidal dispersion. Latices or latexes are plural forms of latex. Paint is an example of a colloidal latex. “Lattice”, on the other hand, refers to a 3-dimensional structure that dispersed particles may exhibit in the continuous phase based on forces such as electrical charges, hydrogen bonding or van der Waal's forces. In many cases the nature and stability of this lattice is dependent on concentration of dispersed phase (i.e. how densely packed it is), and on the pH and viscosity of the continuous phase, exposure (or not) of functional groups such as by the presence or absence of a surfactant or emulsifier.

“Sealing” as used herein refers to the prevention or hindering of the movement of air such as drafts (i.e. convection) that can move through cavities, gaps, and poorly sealed seams whereas “insulating” refers to the prevention or hindering of all forms of heat transfer, including convection, conduction and radiation. Thus, sealing is a specialized case of insulating. Sealing is also important for noise reduction.

The present invention relates to foams used to fill cavities of buildings to improve the sealing and insulation properties. Additionally, the inventive foams may be used to seal cracks and crevices, such as those around windows and doors. The foams may also be used to form items such as cushions, carpet backing, mattresses, pillows, and toys. The inventive foams can be used in spray, molding, extrusion, and injection molding (e.g., reaction injection molding (RIM)) applications. In one exemplary embodiment, the inventive foam is formed from two components, namely, an A-side and a B-side. In particular, the A-side of the foam composition includes a functionalized water-dispersible and/or a functionalized water-soluble resin (e.g., a functionalized latex or a functionalized latex and an acrylic solution) and the B-side contains a crosslinking agent, and optionally, a non-reactive resin (e.g., a non-functionalized latex). Either or both the A-side or the B-side may contain a blowing agent package. Alternatively, the A-side and the B-side may each contain a component forming a blowing agent package. A plasticizer, a surfactant, a thickener, and/or a co-solvent may optionally be included in either the A- and/or B-side.

In an alternate embodiment, the crosslinking agent and an acid or a base are encapsulated in an encapsulating material to form a one-part foam composition. In a further alternate embodiment, the foamable composition includes a functionalized water-dispersible and/or a functionalized water-soluble resin, a crosslinking agent, and an encapsulated dry acid and/or dry base. In another exemplary embodiment, every component but the functionalized water-dispersible and/or a functionalized water-soluble resin is encapsulated. Unlike conventional spray polyurethane foams, the foams of the present invention do not contain isocyanate. Therefore, no MDI monomers are present in the inventive foams. Because the inventive foam does not contain isocyanate, no harmful chemicals are emitted during installation of the foams.

In exemplary embodiments, the foams of the present invention, as well as the components thereof, meet certain performance properties, or Fitness for Use (“FFU”) criteria, both chemical and physical. In particular, desired criteria or FFUs that the inventive foam should meet are set forth in the table below:

| Chemical Criteria | Physical Criteria |
|---|---|
| The foam should adhere to various | The foam weight should be between about |
| materials such as wood, metal, | 0.5 and about 30.0 pounds per cubic foot |
| concrete and plastic | The foam should be fluid enough to be |
| The chemical constituents should be as | sprayed either at room temperature or by |
| safe as possible. If a hazardous | heating (viscosity of <10,000 cP at a high |
| chemical is used, it should not be | shear rate) |
| introduced or atomized into the air | The foam should not sag or fall in the cavity |
| where it can be inhaled | The foam should fill in cracks and crevices |
| The foam may be chemically foamed | or be used to coat the cavity with an air |
| through the use of a blowing agent or | barrier |
| it may be mechanically foamed with a | Ideally, the cell structure of the foam (closed |
| gas | vs. open) should be a mixture of both a |
| The installer of the foam should be | closed and open cell structure to provide |
| able to work with the material without | appropriate material properties to achieve |
| any specialized personal protective | the other FFUs |
| equipment (“PPE”), such as a | The foam should have a thermal resistance |
| breathing apparatus, although | (R-value) of at least 3.0° F. ft²h/BTU per inch |
| chemical goggles, dust mask, and | The foam should be non-sagging and non- |
| gloves are acceptable | dripping (i.e., fire retardant) during a fire |
| The foam should not lend itself to | The foam should not corrode metal objects |
| molding or fungus growth (ASTM | such as screws, nails, electrical boxes, and |
| C1338) | the like |
| The foam should not contain a food | Air infiltration should be negligible (ASTM |
| source for insects or rodents | E283-04) (spec 0.4 cfm/sq ft) |
| There should be a minimum shelf life | Water vapor infiltration should be greater |
| of the un-reacted constituents of 9 | then 1 perm or 5.72 × 10⁻⁸ g/Pa-s-m² |
| months. | The foam should have low or no odor. |

### Polymeric Resins and Colloids

As discussed above, the A-side of the composition for the foams according to one exemplary embodiment of the present invention includes a functionalized water-dispersible and/or a functionalized water-soluble resin. Preferably, the functionalized water-dispersible resin is a functionalized latex, and even more preferably, the latex system is an acrylic emulsion. Non-limiting examples of suitable water-soluble resins for use in the inventive compositions include acrylic solutions and polyols. In addition to the functionalized water-dispersible and/or functionalized water-soluble resin, the serum can contain a polyacrylic oligomer to increase the total number of the functional groups. It is to be appreciated that although any functionalized water-soluble and/or functionalized water-dispersible resin(s) may be used as a component in the foamable compositions described herein, reference will be made to a preferred embodiment, functionalized latexes with or without an acrylic solution.

There are numerous types of latexes that may be used as the functionalized water-dispersible component in the aqueous resin solution of the present invention. Non-limiting examples of suitable latexes include natural and synthetic rubber resins, and mixtures thereof, including thermosettable rubbers; thermoplastic rubbers and elastomers including, for example, nitrile rubbers (e.g., acrylonitrile-butadiene); polyisoprene rubbers; polychloroprene rubbers; polybutadiene rubbers; butyl rubbers; ethylene-propylene-diene monomer rubbers (EPDM); polypropylene-EPDM elastomers; ethylene-propylene rubbers; styrene-butadiene copolymers; styrene-isoprene copolymers; styrene-butadiene-styrene rubbers; styrene-isoprene-styrene rubbers; styrene-ethylene-butylene-styrene rubbers; styrene-ethylene-propylene-styrene rubbers; polyisobutylene rubbers; ethylene vinyl acetate rubbers; silicone rubbers including, for example, polysiloxanes; methacrylate rubbers; polyacrylate rubbers including, for example, copolymers of isooctyl acrylate and acrylic acid; polyesters; polyether esters; polyvinyl chloride; polyvinylidene chloride; polyvinyl ethers; polyurethanes and blends; and combinations thereof, including, for example, linear, radial, star, and tapered block copolymers thereof. The preferred latex for use in the inventive foam composition is a carboxylated acrylic latex.

As discussed above, water-dispersible and water-soluble resin is functionalized. The functional group may be any functional group capable of crosslinking, including carboxylic acid, hydroxyl, methylol amide groups, and sulfonates. It is preferred that the water-dispersible and/or water-soluble resin(s) contain from about 1.0 to about 20 wt % functional groups based on the total dry weight of the resin, and even more preferably from about 2.0 to about 15.0 wt % functional groups based on the total dry weight of the resin. The functionality of the functionalized water-dispersible and/or water-soluble resin can be adjusted by adding or removing functional groups to or from the resin backbone to reach the optimum amount of crosslinking and ultimately the optimum strength and modulus of the foam. In preferred embodiments, a polyacrylic solution is added in amount sufficient to add up to about 50% carboxylate functionality to the final dry foam composition.

### Crosslinking Agent—Scaffold Former

The B-side of the foam composition, as indicated previously, contains a crosslinking agent and optionally, a non-reactive resin such as, for example, a non-functionalized latex. In particular, the non-reactive resin is a resin that does not react with the crosslinking agent, but is otherwise non-limiting. The crosslinking agent is a compound that crosslinks at or above room temperature, such as polyfunctional aziridines (e.g., XAMA, available from Bayer Corporation). Other suitable crosslinking agents include, but are not necessarily limited to, multifunctional carbodiimides (e.g., Hardner CD, available from Rotta Corporation), melamine formaldehyde, polysiloxanes, and multifunctional epoxies (e.g., cycloaliphatic diepoxides). It is to be appreciated that when a polyfunctional aziridine (e.g., XAMA) is used as the crosslinking agent, other compounds such as plasticizers or epoxy diluents may be utilized to carry the polyfunctional aziridine and lower the viscosity of the B-side. The crosslinking agent may be present in the B-side in an amount from about 1.0 to about 30 percent by weight of the dry foam composition, preferably in an amount from about 3.0 to about 20 percent by weight. Although a mole ratio of the resin functional groups to the crosslinking agent functional groups of 1:1 is preferred, this molar ratio is variable and may encompass a wider range, such as, for example, from 0.5:1 to 2:1 to provide the optimum crosslinking in the final foam products.

The reactive or functional crosslinking groups are provided in pairs, the first reactant generally containing the one member of the pair and the second reactant containing the other member of the pair. The members of the pair react to crosslink at or about room temperature and without the addition of significant heat. For this purpose, heat added by an application device to vaporize a serum phase blowing agent is not considered significant heat. Consequently, the first and second reactants are isolated prior to use in an application of the foamable composition. The first and second reactants are isolated from one another in some embodiments by providing them in two separate and distinct dispersions, as it known in the case of polyurethane and latex spray foams: an A-side and a B-side. Alternatively, they may be isolated by encapsulation or protection of the reactive groups, which encapsulation or protection is removed during the application process. These mechanisms are described in more detail below.

Pairs of reactants and their reactive functional groups suitable for the scaffold-forming reactant system include but are not limited to:

(a) a polyfunctional aziridine and a polyfunctional (carboxylic) acid;

(b) a polyfunctional (isocyanate) oligomer and a polyfunctional (hydroxyl) alcohol; and

(c) a polyfunctional (amine) and a polyfunctional (epoxy) oligomer.

Polyfunctional in this context refers to at least two (difunctional), three (trifunctional) or higher level of reactive groups per backbone molecule. Three or more reactive groups per backbone molecule are considered polyfunctional or multifunctional. Each pair member of the scaffold-forming reactant system will have an “effective equivalent” number of functional groups that may be estimated theoretically and determined empirically. The “effective equivalent” number of functional groups is often less than the actual number due to the inevitable steric hindrance of some functional groups in larger molecules. In general, it is desirable to provide the first reactant and second reactant in equal “effective equivalents” i.e. in a 1:1 molar ratio considering moles of available or “effective” functional groups. However, this ratio is variable and may encompass a wider range, such as, for example, from 0.5:1 to 2:1 to provide the optimum crosslinking in the final foam products. When functionalized polymers are employed, the ratio may ideally be adjusted to add more equivalents of whichever reactant tends to react with functional groups of the polymer.

### Blowing Agent Package

Additionally, the A-side and/or B-side contains a blowing agent package. The blowing agent package may be the combination of two or more chemicals or compounds that when mixed together form a gas (e.g., an acid and a base are discussed below) or a chemical compound that, when heat or light activated, forms a gas. The generated gas may be CO₂, N₂, O₂, H₂, or other non-carcinogenic, gases. For instance, azodicarbonamide is a chemical compound that, upon heating, releases N₂ gas, and would be a suitable blowing agent in the foamable composition. Additionally, alkylsiloxanes, which may release H₂ when reacting with amine hardeners, may be used as a blowing agent in the instant invention. Other examples include diazo compounds (i.e., CH₂N₂) and aliphatic azide (i.e., R—N═N═N), which decompose on irradiation to give nitrogen gas, and 1-naphtyl acetic acid and n-butyric acid, which generate carbon dioxide (CO₂) upon photodecarboxylation. Phase change blowing agents such as low boiling point hydrocarbons (e.g., cyclopentane and n-pentane) and inert gases such as air, nitrogen, carbon dioxide can also be used. It is to be appreciated that the chemical compound is not a conventional blowing agent in the sense that it is a hydro-fluorocarbon (HFC) or a hydro-chloro-fluorocarbon (HCFC) blowing agent. Preferably, the generated gas is stable, non-explosive and relatively inert, such as carbon dioxide.

If the blowing agent package is a single chemical compound, the compound may be included in either the A- or the B-side. On the other hand, if the blowing agent package is formed of two compounds, such as an acid and a base that react to form a gas when mixed, the two components are separated by encapsulation in one-part foams, and/or in two-part foams they may be placed with one component in the A-side and the other component in the B-side.

For instance, an acid and a base forming the blowing agent package may be separated and the acid placed in the A-side and the base placed in the B-side (or vice versa). Thus, in addition to the functionalized latex solution, the A-side may contain at least one acid. In exemplary embodiments, the acid is a polyacrylic acid that reacts with a base to generate CO₂. Additionally the polyacrylic acid reacts with the crosslinking agent to become part of the foam structure (e.g., integrated with the foam structure). The acid may have a solubility of 0.5 g/100 g of water or greater at 30° C. Also, the acid may be a dry acid powder with or without chemically bound water. Non-exclusive examples of suitable acids include citric acid, oxalic acid, tartaric acid, succinic acid, fumaric acid, adipic acid, maleic acid, malonic acid, glutaric acid, phthalic acid, metaphosphoric acid, or salts that are convertible into an acid that is an alkali metal salt of citric acid, tartaric acid, succinic acid, fumaric acid, adipic acid, maleic acid, oxalic acid, malonic acid, glutaric acid, phthalic acid, metaphosphoric acid, or a mixture thereof. Examples of salts which are convertible into acids include, but are not limited to, aluminum sulfate, calcium phosphate, alum, a double salt of an alum, potassium aluminum sulfate, sodium dihydrogen phosphate, potassium citrate, sodium maleate, potassium tartrate, sodium fumarate, sulfonates, and phosphates. The acid(s) may be present in an amount from about 1.0 to about 30 percent by weight of the dry foam composition, preferably in an amount from about 3.0 to about 20 percent by weight.

The acid and base of the blowing agent package are separated until use, such as when encapsulated as explained herein, or in two-part foamable compositions when, for example, the A-side contains the acid and the B-side contains the base. The base may be present in an amount from about 1.0 to about 30% by weight of the dry foam composition. In preferred two-part embodiments, the base is present in the B-side in an amount from about 3.0 to about 20% by weight, or from about 3.0 to about 8% by weight, of the B-side. In one embodiment, sodium bicarbonate and polyacrylic acid in a ratio of 10:1 to 1:1 are the preferred base and acid acting as the blowing agent package.

Generally, the weak base contains anionic carbonate or hydrogen carbonate (“bicarbonates”) and an alkali metal, an alkaline earth metal or a transition metal as a cation. Examples of bases suitable for use in the practice of this invention include calcium carbonate, barium carbonate, strontium carbonate, magnesium carbonate, lithium carbonate, sodium carbonate, potassium carbonate, rubidium carbonate, cesium carbonate, calcium hydrogen carbonate, barium hydrogen carbonate, strontium hydrogen carbonate, magnesium hydrogen carbonate, lithium hydrogen carbonate, sodium hydrogen carbonate, potassium hydrogen carbonate, rubidium hydrogen carbonate, cesium hydrogen carbonate, and bicarbonates and combinations thereof. In preferred embodiments, the base is sodium bicarbonate.

In some exemplary embodiments, the sodium bicarbonate has a mean particle size from about 2 to about 40 microns, and most preferably a mean particle size of 11 microns. The sodium bicarbonate may be milled or otherwise ground to achieve the desired size. It has been surprisingly discovered that by utilizing such a small particle size, the rate of rise of the inventive foam was approximately ten times faster compared to foams made according to the present invention with sodium bicarbonate that has not been milled (e.g., sodium bicarbonate having a particle size from 200-300 microns). This significant improvement in the rate of rise of the foam enables a worker to apply the foam and quickly determine whether or not the gap has been filled.

Bicarbonate powders may be milled to this size using various milling devices, including, for example, attritors, ball mills and jet mills. The operation of ball mills, attritors and jet mills is well understood, so that minimal description is included here. These mills operate on the principle mechanical maceration of the particulates by impinging on spherical balls, other particulates or walls of the mill driven by forces of gravity and/or air streams. Unfortunately, these types of mills are less efficient than media mills and typically operate in ambient conditions, which enables the bicarbonate to absorb ambient moisture from the surrounding air. The presence of this water may be adverse to other reactants of the spray foams (e.g. polyaziridines).

In other exemplary embodiments, the sodium bicarbonate has a mean particle size from about 0.5 to about 5 microns, and most preferably a mean particle size of about 1.3 to about 2.0 microns, e.g. about 1.4 to about 1.7 microns. Depending on the skew of the particle size distribution, the mean size may be equal to, greater than or less than the median size, which is the size at which 50% are smaller and 50% are larger, also known and the “d50”. Both mean and median are statistical measures of central tendency. If the milling process produces a distribution with a longer tail of smaller particles, the mean is generally smaller than the median; but if the process produces a longer tail of larger particles, the mean is generally greater than the median. When the tails of the distribution are roughly equal, as in a uniform distribution, the mean and median approach the same number.

To achieve this smaller particle size, the sodium bicarbonate may be milled or otherwise ground using, for example, a media milling device. Media mills are also quite well understood and include small pellets or particles of a milling media, such as metal, ceramic, glass or polymeric plastic. Metals include e.g. steel, carbon steel, stainless steel and chrome coated steel. Non metal media includes, e.g. alumina, ceramic, glass, mullite, nylon, silicon carbide or silicon nitride, tungsten carbides, zirconium oxides (stabilized) and zirconium silicates. All of these media pellets are available from Union Process of Akron, Ohio. Depending on the composition, the size of the media pellets ranges from about 0.1 mm to about 30 mm. One skilled in the art can easily select the right size media for the desired final particulate size; even possibly including two passes with different sized media to achieve a desired result. Some manufacturers of suitable horizontal media mills include: Netzsch, Custom Milling & Consulting (CMC), Union Process, and Chicago Boiler.

FIG. 1 is a schematic, partially cross-sectioned representation of a horizontal media mill 10. The mill 10 comprises a cylindrically-shaped housing 12 defining an interior 13. The housing 12 provided an inlet 14 and an outlet 16 for communication of the interior with the exterior. In addition, a drain plug 18 may be provided and filtering screens 20a, 20b may be provided in sizes appropriate to retain media in the interior 13. At one end, the cylindrical housing 12 is closed by a removable cover 22. At the other end of the housing, mechanical seals 24 and/or fluid seals 26 bear against shaft 28 which extends axially into the cylindrical housing 12. One end of the shaft 28 is connected to a motor 30 controlled by controls 32 so as to rotate the shaft 28 within the cylindrical housing 12. Agitator blades 34 are attached to the shaft 28 and extend radially outwardly toward the housing 12. The agitator blades 34 may be substantially planar and perpendicular to the axis of the shaft 28, but this is not required. Multiple agitator blades 34 may be present spaced apart axially along the shaft 28, but any shape or configuration of agitator blades suitable for the conditions may be employed. Since heat may be generated in use, a coolant fluid housing or jacket 36 may be provided around the outside of cylindrical housing 12, and it may have an inlet 38 an outlet 40 and a pump 42 to provide a flow of coolant fluid such as water around the outside of the housing 12.

In use, the cylindrical housing 12 is filled or nearly filled with a milling media, described above and represented as dots 48 in the interior 13. A fluid containing the particles to be ground is admitted to the housing interior 13 through inlet 14. The controls 32 are operated to cause the motor 30 to rotate the shaft 28 to cause frictional grinding of the particles among the agitator blades 34, the housing 12, and the media 48; and among the media 48 and the agitator blades 34 and the housing 12. This friction often generates heat, so the controls 32 may also cause pump 42 to circulate coolant through the jacket 36 to cool the mill 10. The mill may be operated in either batch mode with the inlet and outlets closed off, or continuous mode with a supply of particulates from a source (not shown) connected to the inlet and outlet. Recirculation is common and often necessary to achieve a desired particle size.

In addition to the increased speed of reaction of smaller particles, several other advantages have been discovered. First, a smaller quantity of the blowing agent may be employed. The increased total surface area of these smaller particulates enables greater stoichiometric access for chemical reaction. Thus, equivalent reaction and gas generation can be achieved with reduced quantities of ingredients, which is more efficient. In some embodiments, the amount of dry powder base (e.g. sodium bicarbonate) was reduced by more than 50%, i.e. from 13.5% to 6% of the composition. This means less sodium is available to corrode metallic parts the foam may come into contact with. Second, the smaller particulate size enables the formation of colloidal suspensions or solutions that are stable for longer periods, up to indefinitely, without added suspending agents, stabilizers and the like.

Third, the more efficient use of smaller quantities of ingredients improves the sealing resistance to air flow. Good foam formation requires a careful balance of timing: the scaffold, the film-forming polymer resin and the gas generation all must proceed with careful sequencing. With larger particulates, especially at lower temperatures, some of the base powder was left in unreacted, solid form trapped in the resin until after the film had gelled. Eventually, and especially upon exposure to warmer temperatures, this unreacted base can react to generate gas after the film is gelled, a phenomenon known as “latent gassing.” Latent gassing can cause pinhole ruptures or cracking of the polymer film, which permits air to flow (convection) and reduces both sealing and insulation R-value. Using smaller particles allows better sequence timing so that all the reactants can be used up prior to gelling of the film, thus reducing latent gassing and improving sealing properties. Additionally, these stable colloidal suspensions or solutions can be applied at colder temperatures with reduced risk of latent gassing.

Finally, the use of media milling enables the powder to be finely ground in a vehicle that can exclude water and the excess moisture of “tramp water” that can be imbibed by hygroscopic powders. Thus, carbonates and bicarbonates can be milled to very fine sizes without drawing in ambient moisture, which can be detrimental to other ingredients of foamable compositions as mentioned above. In some embodiments, the carbonate or bicarbonate base powder is milled in a non-aqueous phase in which a plasticizer (discussed below) serves the vehicle or serum for the component.

### Other Optional Ingredients

In addition to the components set forth above, the A-side and/or the B-side may contain one or more surfactants to impart stability to the acrylic during the foaming process, to provide a high surface activity for the nucleation and stabilization of the foam cells, and to modify the surface tension of the latex suspension to obtain a finely distributed, uniform foam with smaller cells. Useful surfactants include cationic, anionic, amphoteric and nonionic surfactants such as, for example, carboxylate soaps such as oleates, ricinoleates, castor oil soaps and rosinates, quaternary ammonium soaps and betaines, amines and proteins, as well as alkyl sulphates, polyether sulphonate (e.g., Triton X200K available from Cognis), octylphenol ethoxylate (e.g., Triton X705 available from Cognis), disodium N-octadecyl sulfosuccinamate (e.g., Aerosol 18P available from Cytec), octylphenol polyethoxylates (e.g., Triton X110 available from Cognis), alpha olefin sulfonate, sodium lauryl sulfates (e.g., Stanfax 234 and Stanfax 234LCP from Para-Chemicals), ammonium laureth sulfates (e.g., Stanfax 1012 and Stanfax 969(3) from Para-Chemicals), ammonium lauryl ether sulfates (e.g., Stanfax 1045(2) from Para-Chemicals), sodium laureth sulfates (e.g., Stanfax 1022(2) and Stanfax (1023(3) from Para-Chemicals), sodium sulfosuccinimate (e.g., Stanfax 318 from Para-Chemicals), and aliphatic ethoxylate nonionic surfactants (e.g., ABEX available from Rhodia). The surfactant may be present in the A- and/or B-side in an amount from about 0 to about 20% by weight of the dry foam composition.

Further, either or both the A-side and B-side may contain a thickening agent to adjust the viscosity of the foam. It is desirable that the A-side and the B-side have the same or nearly the same viscosity to achieve a 1:1 ratio of the A-side components to the B-side components. A 1:1 ratio permits for easy application and mixing of the components of the A-side and B-side. Suitable examples of thickening agents for use in the foamable composition include calcium carbonate, methyl cellulose, ethyl cellulose, hydroxyethyl cellulose (e.g., Cellosize® HEC available from Union Carbide), alkaline swellable polyacrylates (e.g., Paragum 500 available from Para-Chem), sodium polyacrylates (e.g., Paragum 104 available from Para-Chem), bentonite clays, and Laponite® RD clay (a synthetic layered silicate), glass fibers, cellulose fibers, and polyethylene oxide. The Laponite® products belong to a family of synthetic, layered silicates produced by the Southern Clay Products Corporation. The Laponite® products are thixotropic agents that Any reactive latex solids content may be employed in the latex emulsion, provided that the composition of this invention is achieved. The reactive latex solids content of the emulsion may be greater than about 30 weight percent, preferably, greater than about 40 weight percent, and more preferably, greater than about 50 weight percent, based on the total weight of the emulsion. Additionally, the reactive latex solids content of the emulsion may be less than about 80 weight percent, preferably, less than about 70 weight percent, and more preferably, less than about 62 weight percent, based on the total weight of the emulsion.

It is preferred that the latex employed in the latex emulsion be stabilized. In order to achieve an acceptable stability, the latex emulsion may include a stabilizer, as discussed above. It is desirable that the stabilizer create a basic environment for the latex. Ammonia is a preferred stabilizer. Preferably, a basic ammonia solution having a pH between about 8 and about 12, preferably about 10, is used. Other caustic materials that can be used to stabilize the latex emulsion include, for example, potassium hydroxide and sodium hydroxide.

Additionally, the latex emulsion may include a surfactant. Although not wishing to be bound by theory, it is believed that the surfactant coats the latex (or “lattice”) particles with the negatively charged tail facing away from the particle, such that the positively charged serum creates an environment where the particles repel each other. It is also believed that the surfactant layer forms an interfacial film with water (i.e., a hydration layer) around the particle. The raw lattices are stable only when this film is intact. Because the lattice particles are in the micron range they are further stabilized by Brownian motion. Further, because the lattice particles are negatively charged, the latex is considered anionic.

The latex emulsion is present in an amount from about 60 to about 95 weight percent of the spray latex foam. Preferably, the latex emulsion is present in an amount from about 70 to about 85 weight percent of the spray latex foam.

In addition to the latex emulsion described above, the latex system may include a thixotropic agent, especially for lower density foams (i.e., no more than about 2 pounds per cubic foot). The thixotropic agent “virtually freeze” the foam structure while the structure is curing to prevent the structure from collapsing. As used herein, the phrase “virtually freeze” is meant to denote a previously fluid/viscous material that is now substantially immobilized by an internal scaffolding-like structure, which may be provided by a thixotropic agent. The thickening agent may be present in an amount up to about 50% by weight of the dry foam composition. Preferably, the amount of thickening agent present is about 0 to about 20% by weight, based on the dry foamable composition, depending upon the nature of the thickening agent.

According to some embodiments of the invention, the foamable composition may include a plasticizer in the A-side and/or B-side to adjust the viscosity of the foam. The plasticizer may be present in the foamable composition in an amount from about 0 to about 20% by weight of the dry foam composition. Desirably, the plasticizer is present in an amount from about 0 to about 15% by weight. Plasticizers are known to lower the glass transition temperature (Tg) of polymers and may be used to facilitate softening of the polymer resins or colloid particles, leading to coagulation to the film. Useful plasticizers have been found in the di/tri-carboxylic ester class and the benzoate ester class, although other classes may be suitable. Non-limiting examples of suitable plasticizers include phthalate ester, dimethyl adipate, dimethyl phthalate, acetyl tri-n-butyl citrate, benzoate esters, and epoxidized crop oils (e.g., Drapex 10.4, Drapex 4.4, and Drapex 6.8 available from Chemtura). Some specific plasticizers include Benzoflex® 2088 (a butyl benzoate ester plasticizer available from Genovique Specialties), Benzoflex® LA-705 (a benzoate ester plasticizer available from Genovique Specialties), Citroflex® 2 (a triethyl citrate available from Vertellus® Specialties), and Citroflex® 4 (a tributyl citrate available from Vertellus® Specialties). In exemplary embodiments, the plasticizer is a benzoate ester or a citric acid ester.

In embodiments employing separate A-side and B-side dispersions, the plasticizer may be additionally useful as a vehicle or medium for B-side dispersions, thus diluting one of the crosslinking or scaffold-forming reactants. For example, diluting a polyfunctional aziridine provides several advantages. First, the concentration of polyfunctional aziridine is lowered, reducing health risks to those in contact with it. Polyfunctional aziridine contains about 0.001% of ethyleneimine, which is a very reactive moiety, and in theory, will react with the very small level of acid impurities or water content that may be present in other components of the composition. Second, the viscosity of the B-side is reduced when the polyfunctional crosslinking reactant is diluted with the plasticizer. As a result, the components of the B-side can be better mixed with the A-side to form a more homogeneous mixture. Finally, the plasticizer adds volume to the B-side, allowing the two parts of the foam composition to be delivered in ratios that more closely approach 1:1, and thus they can be delivered with known spray equipment, thereby negating the need for any specialized equipment.

Additionally, the presence of the plasticizer permits for the inclusion of other solid materials that may add functionality and/or cost savings to the final foamed product. For instance, coagulation agents, fillers (e.g., calcium carbonate and wollastonite fibers), nucleating agents (e.g., talc), and/or foaming agents (e.g., sodium bicarbonate) can be included in the B-side of the foamable composition. The inclusion of fillers such as wollastonite fibers helps with the stability of the cell structure after the cells have been formed. It is to be appreciated that when the plasticizer and other components in the B-side do not contain any acidic protons, the B-side is stable for extended periods of time, such as up to at least six months or more.

Further, an alcohol such as ethanol or isopropanol may be present in the foam composition in the A-side and/or the B-side. The alcohol is preferably miscible with water and has a low boiling point. The alcohol acts as a co-solvent and replaces a portion of the water in the latex serum. Utilizing an alcohol co-solvent allows for a quicker drying/curing time after the foam's application. Additionally, the co-solvent assists in creating a foam with a fine cell structure. Although not wishing to be bound by theory, it is believed that the higher vapor pressure of the alcohol causes the alcohol to be driven off more quickly than the water in the latex solution, and that the alcohol carries the water molecules as the alcohol is removed. The co-solvent is used in small quantities, typically from about 1.0 to about 5.0% by weight of the foam composition.

To form a two-part spray foam of the present invention, the components of the A-side and the components of the B-side are delivered through separate lines into a spray gun, such as an impingement-type spray gun. Alternatively, spray guns utilizing static mixers to combine the components of the A-side and the components of the B-side, as well as other dynamic mixers, may be used. The two components are pumped through small orifices at high pressure to form streams of the individual components of the A-side and the B-side. The streams of the first and second components intersect and mix with each other within the gun and begin to react. For example, in embodiments where the acid is contained in the A-side and the base is contained in the B-side), the acid and base react to form a gas, such as carbon dioxide (CO₂) gas. In any event, the foaming reaction occurs until all of the blowing agent(s) have been reacted and no more gas is generated.

In addition, the crosslinking agent concurrently (simultaneously) reacts with the functional groups on the acrylic (e.g., acrylic latex and polyacrylic acid) to support the foamed structure. The crosslinking is important for capturing the bubbles generated by the evolution of the gas in their original, fine structure before they can coalesce and escape the foam. It is to be appreciated that a fine foam structure is more desirable and more beneficial than a coarse foam structure in order to achieve high thermal performance. Additionally, the crosslinking of the functional groups on the functionalized latex quickly builds strength in the foam and permits the foam to withstand the force of gravity when it is placed, for example, in a vertical wall cavity during application. The final foamed product becomes cured to the touch within minutes after application. In exemplary foamed products, the foam cures within about 2 minutes. The resulting resistance to heat transfer, or R-value, may be from about 3.5 to about 8 per inch.

In an alternate embodiment, the blowing agent package includes an acid and a base and the components of the B-side are encapsulated and added to the A-side, thereby creating a one-part foam composition. Specifically, the crosslinking agent and the base (i.e., acid sensitive chemical blowing agent) are encapsulated in one or two protective, non-reactive shells that can be broken or melted at the time of the application of the foam. For example, the crosslinking agent and the base may be encapsulated in a wax or gelatin that can be melted at the time of the application of the foam. Desirably, the wax has a melting point from about 120° F. to about 180° F., and more preferably has a melting point from about 120° F. to about 140° F. Alternatively, the encapsulating shell may be formed of a brittle polymer (such as a melamine formaldehyde polymer) or an acrylic that can be broken or sheared at the time of the application of the foam to initiate the foaming reaction. The protective shell(s) surrounding the crosslinking agent and base may be heat activated, shear activated, photo-activated, sonically destructed, or activated or destroyed by other methods known to those of skill in the art.

Optionally, the encapsulating material may be a low melting, semi-crystalline, super-cooled polymer. Non-limiting examples of low melting polymers include polyethylene oxide (PEO) and polyethylene glycol (PEG). A preferred low-melting polymer for use as an encapsulant is a polyethylene oxide that has an average molecular weight from about 100,000 Dalton to about 8,000,000 Dalton. Additionally, the glass transition temperature (T_{g}) of the super-cooled polymer may be adjusted to the application temperature of the reaction system by blending polymers. For example, polymer blends such as a blend of polyvinylchloride (PVC) and polyethylene oxide (PEO) may be used to “fine tune” the glass transition temperature and achieve a desired temperature at which the polymer melts or re-crystallizes to release the crosslinking agent and base. With a PVC/PEO blend, the desired glass transition temperature is a temperature between the T_{g} of polyvinyl chloride and the T_{g} of the polyethylene oxide and is determined by the ratio of PVC to PEO in the polymer blend. When the super-cooled polymer is heated above its glass transition temperature, such as in a spray gun, the polymer re-crystallizes and the crosslinking agent and base is expelled from the polymer. This expulsion of the crosslinking agent and base is due to the change in free volume that occurs after re-crystallization of the polymer.

The combination of the A-side components and the encapsulated crosslinking agent and blowing agent(s) may be mixed to form a dispersion (reaction mixture). The dispersion is substantially non-reactive because the crosslinking agent remains encapsulated within the encapsulating shell. The phrase “substantially non-reactive” as used herein is meant to indicate that there is no reaction or only a minimal reaction between the A-side components and the encapsulant in the dispersion. As a result, the one-part foamable reactive composition is stable for extended periods of time.

A single stream of the dispersion containing the functionalized latex, encapsulated crosslinking agent and blowing agent, and optional surfactants, plasticizers, thickening agents, and/or co-solvents may then be fed into an application gun, such as a spray gun, that has the ability to mix and/or heat the dispersion within the gun. The one-part foam of the present invention requires no expensive or complicated spraying equipment, and is a simple gun, a simple diaphragm, or drum pump. These types of guns are less likely to clog and are also easy to maintain and clean.

Once the dispersion is inside the gun, the crosslinking agent and base are released from the encapsulating material. For example, the dispersion may be heated within the gun to a temperature above the melting point of the long chain polymer or wax containing the crosslinking agent and base so that the crosslinking agent and base are released from the polymer or wax. In this example, the dispersion is heated to a temperature of about 130° F. to about 180° F. In addition, the mixing action within the gun may assist in the release of the crosslinking agent and base from the encapsulant. Alternatively, the encapsulating shell of the crosslinking agent and base may be shear activated, sonically activated, photo activated, or destroyed by any other suitable method known to those of skill in the art. Once the crosslinking agent and blowing agent package are released from the polymer shell, crosslinking between the crosslinking agent and the functional groups on the functionalized latex begins and the blowing agent concurrently degrades or reacts to form a gas to initiate the foaming reaction and form the foam. The simultaneously reacting mixture is sprayed from the gun to a desired location where the mixture continues to react and form either open or closed cell foams. The foam may have an R-value from about 3.0 to about 8 per inch. The foam is advantageously used in residential housing, commercial buildings, appliances (e.g., refrigerators and ovens), and hot tubs.

In a further alternative embodiment in which a one-part foam composition is utilized, the foam is formed by encapsulating the dry acid powder and the dry, powdered base in a single encapsulating shell, such as the encapsulating shell described in detail above. It is to be appreciated that separately encapsulating the acid and the base is considered to be within the purview of this invention. The encapsulated acid and base are mixed with a functionalized latex solution, at least one crosslinking agent, and optionally one or more of a surfactant, thickener, plasticizer, and/or co-solvent to form a reaction mixture or dispersion. It is to be noted that there is no foaming reaction due to the encapsulation of the acid and base. Consequently, the reactive mixture is stable for extended periods of time. The mixture is of a sufficient viscosity to enable its passage through a spray-type application gun. As with the embodiment discussed previously, the encapsulating shell is destroyed, such as by heat, sonic destruction, shear forces, or other known methods, to release the acid and/or the base. Once the acid and base are released from the encapsulating material, crosslinking between the crosslinking agent and the carboxy groups on the functionalized latex begins and the acid and base react to form a gas, which initiates the foaming reaction and forms the inventive foam.

Other non-limiting, exemplary one-part foam embodiments of the present invention include a foamable composition where the crosslinking agent and acid is encapsulated, the acid or the base is encapsulated, or every component but the functionalized latex is encapsulated. In each of these embodiments, the foaming and crosslinking reactions begin when the encapsulated material is released from the encapsulating, protective shell, such as by heat, sonic destruction, shear forces, or photo activation.

Additionally, the one part-foam compositions or either the A-side or B-side of two-part foams may also include other optional, additional components such as, for example, foam promoters, opacifiers, accelerators, foam stabilizers, dyes (e.g., diazo or benzimidazolone family of organic dyes), color indicators, gelling agents, flame retardants, biocides, fungicides, algaecides, fillers (aluminum tri-hydroxide (ATH)), and/or conventional blowing agents. It is to be appreciated that a material will often serve more than one of the aforementioned functions, as may be evident to one skilled in the art, even though the material may be primarily discussed only under one functional heading herein. The additives are desirably chosen and used in a way such that the additives do not interfere with the mixing of the ingredients, the cure of the reactive mixture, the foaming of the composition, or the final properties of the foam.

Optionally, one or more foam promoters may be included in the latex system. The foam promoter aids in forming a stable foam cell structure. The foam promoters may be selected from quaternary ammonium soaps and betaines, amines and proteins, carboxylate soaps such as oleates, ricinoleates, castor oil soaps and rosinates, and combinations thereof. The preferred foam promoter is a carboxylate soap. A preferred carboxylate soap is potassium oleate. The foam promoter may be used in an amount of up to about 3 weight percent of the spray latex foam, preferably from about 0.5 to about 2.5 weight percent of the spray latex foam.

One or more opacifiers may be used in the latex system to improve the thermal resistance, or insulation value (R-value). Opacifiers that may be used in the latex system include, but are not limited to, carbon, iron oxide, and graphite such as micron-sized graphite and nano-sized graphite. The opacifier may be present in the latex system in an amount up to about 10 weight percent, preferably from about 1 to about 4 weight percent, of the spray latex foam.

Optionally, one or more accelerators may also be present in the latex system of the inventive spray foam. The presence of an accelerator aids in the coagulation process. Coagulation refers to the phenomena of latex particles coming together and the polymer chains interlocking with each other. Non-limiting examples of accelerators useful in the present invention include thiozole compounds such as zinc mercaptobenzythiazolate, polyfunctional oxime compounds such as p,p′-dibenzoylquinone dioxime, and dithiocarbamates such as zinc dimethyl dithiocarbamate and sodium dibutyl dithiocarbamate. If used, the accelerator(s) may be included in the latex system in an amount up to about 10 weight percent, preferably from about 1.5 to about 8 weight percent, of the spray latex foam.

Further, one or more foam stabilizers may be present in the latex system. Foam stabilizers tend to enhance the integrity of the foam in the shaping and setting process and may also act as foaming aids. Non-limiting examples of foam stabilizers include, for example, zinc oxide and magnesium oxide. If used, the stabilizer may be included in an amount up to about 15 weight percent, preferably between about 3 and about 10 weight percent of the spray latex foam. The preferred amount of stabilizer is that which allows the foam stabilizer to become soluble in the serum as the pH becomes acidic and to work with fatty acid soaps (i.e., foam promoters) to form a stable cell structure.

In addition to the latex system described in detail above, the spray latex foam of the present invention includes a gaseous coagulating component that is used to coagulate the latex. Various gaseous coagulants can be employed in the present invention. In a preferred embodiment, the gaseous coagulating component is carbon dioxide. The carbon dioxide acts as a foamant and also promotes coagulation of the spray latex foam. The presence of carbon dioxide acidifies the aqueous matrix of the latex and causes the latex particles to drop out of solution and coagulate. The presence of the carbon dioxide also eliminates the need for any hydrocarbon propellants, though they may be included as optional blowing agents. The carbon dioxide used in the present invention may be pure carbon dioxide gas or it may be derived from other sources that release carbon dioxide during a chemical reaction. Such suitable alternative sources for producing carbon dioxide include, for example, carbonates like ammonium carbonate and bicarbonates like sodium bicarbonate.

In accordance with one exemplary embodiment of the present invention, carbon dioxide is included as a gaseous coagulating agent and is brought to high pressure (e.g., about 100 to about 500 psi) so that it solubilizes in the serum (i.e., water-dispersible resin (e.g., functionalized latex or functionalized latex and acrylic solution), crosslinking agent, and phase change blowing agent are pressurized, such as in a pressurized spray-type container. Upon release of the functionalized water-soluble or functionalized water-dispersible resin, the crosslinking agent, and the blowing agent from the pressurized container (e.g., release into atmospheric pressure), the blowing agent changes from a liquid to a gas to initiate the foaming reaction while the crosslinking agent and functionalized resin react to form an internal foam structure. The foaming reaction continues until all of the blowing agent has been converted into a gas.

In use, the inventive foams may be sprayed into either an open cavity, such as between wall studs, or into a closed cavity where it expands to seal any open spaces. The application is desirably a continuous spray process. Alternatively, the foams may be applied in a manner to fill or substantially fill a mold or fed into an extruder or an injection molding apparatus, such as for reaction injection molding (RIM), and used to form items such as cushions, mattresses, pillows, and toys. For example, a functionalized water-soluble or functionalized water-dispersible resin (e.g., functionalized latex or functionalized latex and acrylic solution), a crosslinking agent, and a blowing agent may be mixed and applied to a mold where the crosslinking agent reacts with the functionalized resin while the blowing agent degrades or reacts to form a gas and initiate the foaming reaction.

In another embodiment, the foams of the present invention may be used to seal the insulative cavities of a building such as a house and minimize or eliminate air flow into the insulative cavities and effectively seal the building. For example, the building frame of a house contains studs generally spaced 16 inches apart externally walled with sheathing formed of boards of wood or other fibrous material(s) (e.g., oriented strand board). The studs and sheathing form insulative cavities in which fibrous insulation is conventionally placed to insulate the building. In the present invention, the inventive foams may be applied to the interface of the sheathing and the studs, the top plate and the sheathing, and/or the bottom plate and the sheathing to seal any possible gaps or spaces between the sheathing and the studs and reduce or even eliminate air leaks and prevent air from entering into the insulative cavity (and into the building). In particular, the foam may be sprayed along the bottom plate, the top plate, and along the vertical length of the studs.

Another advantage of the inventive foams is that it can be used in the renovation market, as well as in houses that are occupied by persons or animals. Existing, conventional spray polyurethane foams cannot be used in these applications because of the generation of high amounts of free isocyanate monomers that could adversely affect the occupants of the dwelling. As discussed above, exposure of isocyanate monomers may cause irritation to the nose, throat, and lungs, difficulty in breathing, skin irritation and/or blistering, and a sensitization of the airways.

Yet another advantage of the present invention is that the components of the one-part foam compositions in which the crosslinking agent and base and/or the acid are encapsulated may be mixed and stored in one container without significant reaction until such time that the foam is used. This simplifies the application of the foam because no other components need to be added at the point of application. Instead, the encapsulated components are activated at the point of application.

It is also an advantage of the present invention is that the components of the one-part or two-part foam compositions are carefully chosen to result in a tacky or sticky foam that can be used to hold the fiberglass batt in place when used to fill cracks or crevices.

The one-part foam compositions are advantageous in they do not require metering within the gun. As a result, a simple spray gun having only one inlet may be utilized to spray the foam compositions. Without a sophisticated pumping system and complex spray gun, producing the inventive one-part foams have low manufacturing costs. In addition, the one-part foamable compositions of the present invention are simpler to use in the field than conventional two-part foams. Therefore, less training is required to correctly use the inventive one-part foam compositions.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

Table 1 sets forth a list of components that may be used to make at least one exemplary embodiment of the inventive foam.

TABLE 1
List of Foam Composition Ingredient Options

| | | |
|---|---|---|
| Trade Name | Description | Manufacturer |

Functionalized Latex

| | | |
|---|---|---|
| Omnapel 6110 | Carboxylated Acrylic Latex | Omnova Solutions, |
| | | Inc. |
| NovaCryl PSP 170 | Carboxylated Acrylic Latex | Omnova Solutions, |
| | | Inc. |
| GenFlo | Carboxylated SBR Latex | Omnova Solutions, |
| | | Inc. |

Non-Functionalized Latex

| | | |
|---|---|---|
| AcryGen DV300 | Acrylic Latex | Omnova Solutions, |
| | | Inc. |
| Vycar 660x144 | Acrylic Latex | Noveon |
| F-6694 | SBR Latex | Omnova Solutions, |
| | | Inc. |

Crosslinking Agents

| | | |
|---|---|---|
| XAMA 7 | Multifunctional Aziridine | Bayer Chemical |
| Lindride 56 | Methylhexahydrophthalic | Lindau Chemical |
| | Anhydride | |
| Hardner CD | Carbodiimide | Rotta Corp. |
| YDH 184 | Cycloaliphatic Diepoxide | Thai Epoxy |

Blowing Agent (Base/Acid pairs)

| | |
|---|---|
| Sodium Bicarbonate/Citric | Aldrich |
| Acid | |
| Sodium Carbonate/Citric | Aldrich |
| Acid | |
| Calcium Carbonate/Sodium | Aldrich |
| Bicarbonate/Citric Acid | |
| Sodium Bicarbonate/Poly- | Solvay/Rohm&Haas |
| acrylic Acid | |
| Potassium Bicarbonate/Poly- | |
| acrylic acid | |

Surfactant

| | | |
|---|---|---|
| G-5M Triton | Non-ionic Surfactant | Dow Chemical |
| ABEX | Non-ionic Surfactant | Rhodia |
| Stanfax 234 | Sodium Lauryl Sulfate | ParaChem |
| Aerosol 18P | disodium N-octadecyl | Cytec |
| | sulfosuccinamate | |

Thickening Agents

| | | |
|---|---|---|
| Cellosize ® HEC | Hydroxyethyl Cellulose | Dow Chemical |
| Laponite ® | Clay | Southern Clay |
| Cabosil | Fumed Silica | Cabot |
| Garamite 1958 | Nanoclay | Southern Clay |
| Optigel | clay | Southern Clay |

Plasticizer

| | | |
|---|---|---|
| Dioctyl Adipate | | Aldrich |
| Diisoocytyl | | Aldrich |
| Adipate | | |
| Dimethyl Phthalate | | Aldrich |
| Dioctyl Phthalate | | Aldrich |
| Citroflex 4 | Acetyl tri-n-butyl citrate | Vertullus |

Encapsulants

| | |
|---|---|
| Melamine Formaldehyde | Aldrich |

Acrylic Solution

| | | |
|---|---|---|
| AcryGen 8546 | 26% Acrylic Solution | Omnova Solutions, |
| | | Inc. |

Examples of forming the foam, encapsulated catalyst, and the reactive mixture using typical exemplary components identified in Table 1 are set forth in Tables 2, 3, and 4.

TABLE 2
Two-Part Foam Compositions

| | Foam 1 | | Foam 2 | | Foam 3 | | Foam 4 | | Foam 5 | |
|---|---|---|---|---|---|---|---|---|---|---|
| | (grams) | | (grams) | | (grams) | | (grams) | | (grams) | |
| Component | A-side | B-side | A-side | B-side | A-side | B-side | A-side | B-side | A-side | B-side |
| NovaCryl | | | 900 | | | | | | 870 | |
| Acrylic Solution | | | 18 | | | | | | | |
| Citric Acid | 45 | | 72 | | 45 | | 36 | | | |
| GR- 5M Triton | | | 9 | | | | | | | |
| GenFlo | | 900 | | 900 | | 900 | | | | 25 |
| Xama-7 | | | | 27 | | 22.5 | | 90 | | 20 |
| Sodium | | 63 | | 63 | | 63 | | 25.2 | | 30 |
| Bicarbonate | | | | | | | | | | |
| Omnapel | 900 | | | | 900 | | 900 | | | |
| YDH 184 | | | | | | 135 | | | | |
| Aerosol 18p | | | | | | | | | 1 | |
| Hardner CD | | 20 | | | | | | | | |
| ABEX | | | | | | | 22.5 | | 1 | |
| Aluminum | | | | | | | | | 200 | |
| tri hydroxide | | | | | | | | | | |
| Calcium | | | | | | | | 65 | | |
| Carbonate | | | | | | | | | | |
| Polyacrylic Acid | | | | | | | | | 67 | |
| Dioctyl Adipate | | | | | | | | 90 | | |
| Stanfax 234 | | | | | | | | | | |
| Citroflex A4 | | | | | | | | | | 25 |
| Cabosil | | | | | | | | | | |
| Dimethyl | | | | | | | | | | |
| Phthalate | | | | | | | | | | |
| Propylene glycol | | | | | | | | | 60 | |
| Optigel | | | | | | | | | 2 | |

TABLE 3
Encapsulated Crosslinking Agent and Blowing Agent

| | Encapsu- | Encapsu- | Encapsu- | Encapsu- |
|---|---|---|---|---|
| | lating | lating | lating | lating |
| | Materials | Materials | Materials | Materials |
| Component | 1 (grams) | 2 (grams) | 3 (grams) | 4 (grams) |
| Sodium | 14 | | 7 | 7 |
| Bicarbonate | | | | |
| Citric Acid | | 14 | 7 | 7 |
| XAMA | 20 | 20 | 20 | |
| Melamine | 10 | 10 | 10 | 10 |
| formaldehyde | | | | |

TABLE 4
One-Part Foam Compositions

| | Foam 1 | Foam 2 |
|---|---|---|
| Component | (grams) | (grams) |
| NovaCryl | 900 | |
| Polyacrylic Acid | 90 | |
| Encapsulating Materials 1 | 64 | |
| (Table 3) | | |
| Omnapel | | 900 |
| GR-5M Triton | 9 | 9 |
| Encapsulating Materials 3 (Table 3) | | 64 |

The encapsulating materials are made by well-known methods known to these skilled in the art of encapsulation, and as such, will not be described herein.

To form a spray foam using the two-part foam composition of Table 2, the A-side components in Table 2 are mixed together and the B-side components are mixed together. Mixtures of the A-side components and B-side components are pumped separately through hoses to an application gun and combined using a dynamic or static mixer. Reactions between the acid and base (to generate bubbles) and reactions between the functionalized latex and the crosslinking agent (to support the foam structure) occur when the foam components are sprayed from the gun to a desired location, such as cavities.

To form a foamed product using the two-part foam composition of Table 2, the A-side components in Table 2 are mixed together and the B-side components are combined together to form a reaction mixture. The reaction mixture formed of the A-side components and B-side components is mixed with a propeller blade and poured into a mold, where it is left to react. When the foam is cured, it is released from the mold in the shape of a desired product.

To form a spray foam using the one part foam composition of Table 4, the components in Table 4 are mixed together. The mixtures are pumped through a hose to an application gun. It is envisioned that the application gun will be equipped with a mixing device that destroys the encapsulating shell containing the blowing agent and crosslinking agent. Reactions between the acid and base blowing agent (to generate bubbles) and reactions between the functionalized latex and the crosslinking agent (to support the foam structure) occur when the foam components are sprayed from the gun to a desired location, such as wall cavities.

### Example 2

### Determination of Air Leakage

Various wall structures were tested for air leakage according to the standards set forth in ASTM E283, which is hereby incorporated herein by reference in its entirety. The framed structures were formed of conventional framing studs spaced 16 inches apart externally walled with sheathing formed of oriented strand boards, similar to that illustrated in FIG. 2. The various iterations of the sample wall structures and air leakage results for each are set forth in Table 5.

TABLE 5
Air Leakage

| | Air Leakage |
|---|---|
| Wall Structure | SCFM @ 75 Pa |
| No Inventive Foam Utilized | |
| Wall without sealant, no seams taped | 37.1^{a} |
| Wall without sealant, seam taped | 37.1^{a} |
| Wall without sealant, seam taped, window | 37.1^{a} |
| covered | |
| Wall insulated and drywalled | 26.5 |
| Wall Sealed with Inventive Foam | |
| Wall sealed with inventive foam and window | 8.4 |
| frame foamed | |
| Wall sealed with inventive foam, insulation | 8.9 |
| positioned in cavity, and drywall affixed to | |
| studs | |
| Wall sealed with inventive foam and scraped | 9.4 |
| off surface, no insulation or drywall | |
| Wall sealed with inventive foam and scraped | 9.3 |
| off surface, insulation positioned in cavity, | |
| drywall affixed to studs | |
| Plastic over window | 8.4 |

^{a}Results shown are an estimate due to the extreme air leakage of these samples.

As shown in Table 5, the wall structures that utilized the inventive foam demonstrated a much lower air leakage compared to the wall structures that did not contain any inventive foam. For instance, a wall structure insulated and drywalled, but which did not contain any inventive foam yielded an air leakage of 26.5 SCFM. On the other hand, wall structures sealed with the inventive foam demonstrated an air leakage of only 8.4 SCFM. Even without the inclusion of any other insulative materials such as insulation positioned within the cavities, the inventive foam provided superior resistance to air leakage compared to those wall structures lacking the inventive foam. Scraping the foam off the surface of the wall structure did not detrimentally affect the resistance of air leakage, and wall samples in which the foam was scraped off demonstrated an air leakage of approximately 9.3 and 9.4 SCFM. It can be concluded that this superior resistance to air leakage caused by the inventive foam also provides improved insulative properties.

### Example 3

### Rate of Rise of Foam Containing Sodium Bicarbonate

A foam according to the present invention was prepared according to the procedure set forth above. In particular, a first component containing a functionalized resin (i.e., a carboxylated acrylic latex) and an acid (i.e., polyacrylic acid) and a second component containing a room temperature crosslinking agent (i.e., a polyfunctional aziridine) and sodium bicarbonate were mixed and the components were permitted to react to form a foam. The foam was permitted to rise to a 700 ml expansion. In one sample, the sodium bicarbonate had a mean particle size of 50 microns. In the second sample, the sodium bicarbonate had a mean particle size of 11 microns. The results are set forth in Table 6.

TABLE 6
Rate of Rise Due To Sodium Bicarbonate

| Size of Sodium Bicarbonate (microns) | Time (seconds) |
|---|---|
| 11 | 28 |
| 50 | 50 |

### Example 4

### Ball Milled Sodium Bicarbonate

Sodium bicarbonate (20%) is added to a Benzoflex 2088 plasticizer and mixed in a ball mill for 72 hours with ⅛ inch zirconia balls at room temperature. The resulting bicarbonate particles are subjected to size analysis using transmitted light optical microscopy at 400× magnification with a digital filar eyepiece with the following results:

Mean diameter (microns)=3.6

Median diameter (microns)=between 2 and 3

Std. deviation (microns)=3.04

Minimum diameter (microns)=0.5

Maximum diameter (microns)=17.8

### Example 5

### Ball Milled Potassium Bicarbonate

Sodium bicarbonate (20%) is added to a Benzoflex 2088 plasticizer and mixed in a ball mill for 72 hours with ⅛ inch zirconia balls at room temperature. The resulting bicarbonate particles are subjected to size analysis using transmitted light optical microscopy at 400× magnification with a digital filar eyepiece with the following results:

Mean diameter (microns)=8.85

Median diameter (microns)=2.5

Std. deviation (microns)=16.11

Minimum diameter (microns)=0.99

Maximum diameter (microns)=394

### Example 6

### Media Milled Sodium Bicarbonate

A quantity of sodium bicarbonate (shown in Table 7) is added to Benzoflex 2088 plasticizer and mixed in a ball mill at concentrations indicated in Table 7. The media and conditions in each case were: Zirmil2 0.8 mm beads for 7 hours; then Zirmil2 beads 0.6 mm for 4 hours. The resulting bicarbonate particles are subjected to size analysis using a Quantimet 550 image analyzer with the following results:

TABLE 7
Particle size analysis, sodium bicarbonate

| | Batch A | Batch B | Batch C |
|---|---|---|---|
| Concentration: | | | |
| wt % sodium biacarbonate | 10% | 15% | 20% |
| Size analysis (volume basis): | | | |
| Mean (microns) | 1.74 | 1.659 | 1.615 |
| Median (microns) | | 0.963 | 1.173 |
| Std Deviation (microns) | | 1.874 | 1.454 |
| smallest decile (<10%) | | 0.185 | .213 |
| smallest quartile (<25%) | | 0.391 | .477 |
| median (<50%) (=d50) | 1.090 | 0.963 | 1.173 |
| largest quartile (<75%) | | 2.180 | 2.343 |
| largest decile (<90%) | 4.206 | 4.192 | 3.695 |
| entire batch (<100%) (=Max) | 18.860 | 15.65 | 10.78 |

### Example 7

### Foams Made from Milled Sodium Bicarbonate

Two foams, D and E, are prepared as set forth in Example 3, except for different milling steps and resultant particle sizes, and different loading amounts of the sodium bicarbonate in the B-side of a two part foam. Details are in Table 8.

TABLE 8
Milled size differences

| | Foam D | Foam E |
|---|---|---|
| Mean particle size of sodium bicarbonate | 11 microns | 1.7 microns |
| | (jet milled) | (media milled) |
| % loading of sodium bicarbonate | 15% | 6% |

Foam E is quicker to rise, gives less latent gassing, and provides a more stable foam with longer shelf life, and does so with a reduced weight percent of sodium bicarbonate.

The invention of this application has been described above both generically and with regard to specific embodiments, although a wide variety of alternatives known to those of skill in the art can be selected within the generic disclosure. The invention is not otherwise limited, except for the recitation of the claims set forth below.

What is claimed is:

1. A two-part foamable composition comprising:
a first component including at least one functionalized resin selected from a functionalized water-dispersible resin and a functionalized water-soluble resin; and
a second component including a crosslinking agent that crosslinks at or about room temperature, and
a blowing agent package, wherein the blowing agent package consists essentially of an acid and a base that, upon combination, react to generate a gas, and wherein one of said acid and base is included in the first component while the other of said acid and base is included in the second component; and wherein the base is a dry powder having a mean particle size of from about 0.5 to about 40 microns.

2. The two-part foamable composition of claim 1, wherein the base is a dry powder having a mean particle size of from about 2 to about 40 microns.

3. The two-part foamable composition of claim 2, wherein the base is dry sodium bicarbonate powder having a mean particle size of about 11 microns.

4. The two-part foamable composition of claim 1, wherein the base is a dry powder having a median particle size of from about 0.5 to about 5 microns.

5. The two-part foamable composition of claim 4, wherein the base is dry sodium bicarbonate powder having a median particle size of from about 0.75 to about 2 microns.

6. The two-part foamable composition of claim 1, wherein said at least one functionalized resin comprises one or more members selected from a functionalized latex and an acrylic solution.

7. The two-part foamable composition of claim 2, wherein said at least one functionalized resin comprises one or more members selected from a functionalized latex and an acrylic solution.

8. The two-part foamable composition of claim 4, wherein said at least one functionalized resin comprises one or more members selected from a functionalized latex and an acrylic solution.

9. The two-part foamable composition of claim 1, wherein said functionalized resin contains from about 1 to about 50 wt % functional groups based on the total weight of said functionalized resin.

10. The two-part foamable composition of claim 1, wherein said crosslinking agent is selected from aziridines, multifunctional carbodiimides, polyfunctional aziridines, melamine formaldehyde, polysiloxanes and multifunctional epoxies.

11. The two-part foamable composition of claim 1, wherein said base is a dry base containing anionic carbonate or hydrogen carbonate and a member selected from an alkali metal, an alkaline earth metal and a transition metal as a cation.

12. The two-part foamable composition of claim 1, wherein one or both of said first component and said second component further comprises one or more members selected from surfactants, thickening agents and plasticizers.

13. A method of making a foamed product using the foamable composition of claim 1, comprising mixing the first and second components in the presence of the blowing agent package and causing the acid and base of the blowing agent package to react to generate a gas.

14. A foamed product produced by the process of claim 13.

15. A one-part foamable composition comprising:
at least one functionalized resin selected from a functionalized water-dispersible resin and a functionalized water-soluble resin;
a crosslinking agent that crosslinks at or about room temperature; and
a blowing agent package, said blowing agent package comprising an acid and a base that, upon combination, react to form a gas, said base being a dry particulate having a median particle size of from about 0.5 to about 50 microns;
wherein said crosslinking agent and at least one of said acid and said base are encapsulated.

16. The one-part foamable composition of claim 15, wherein the base is a dry powder having a mean particle size of from about 2 to about 40 microns.

17. The one-part foamable composition of claim 16, wherein the base is dry sodium bicarbonate powder having a mean particle size of about 11 microns.

18. The one-part foamable composition of claim 15, wherein the base is a dry powder having a median particle size of from about 0.5 to about 5 microns.

19. The one-part foamable composition of claim 18, wherein the base is dry sodium bicarbonate powder having a median particle size of from about 1 to about 2 microns.

20. The one-part foamable composition of claim 15, wherein said at least one functionalized resin comprises one or more members selected from a functionalized latex and an acrylic solution.

21. The one-part foamable composition of claim 16, wherein said at least one functionalized resin comprises one or more members selected from a functionalized latex and an acrylic solution.

22. The one-part foamable composition of claim 18, wherein said at least one functionalized resin comprises one or more members selected from a functionalized latex and an acrylic solution.

23. The one-part foamable composition of claim 15, wherein said functionalized resin contains from about 1 to about 50 wt % functional groups based on the total weight of said functionalized resin.

24. The one-part foamable composition of claim 15, wherein said crosslinking agent is selected from aziridines, multifunctional carbodiimides, polyfunctional aziridines, melamine formaldehyde, polysiloxanes and multifunctional epoxies.

25. The one-part foamable composition of claim 15, wherein said base is a dry base containing anionic carbonate or hydrogen carbonate and a member selected from an alkali metal, an alkaline earth metal and a transition metal as a cation.

26. The one-part foamable composition of claim 15, wherein one or both of said first component and said second component further comprises one or more members selected from surfactants, thickening agents and plasticizers.

27. The one-part foamable composition of claim 15, wherein said crosslinking agent and at least one of said acid and said base are encapsulated in encapsulating materials selected from a wax, a melamine formaldehyde polymer, an acrylic, a gelatin, polyethylene oxide, polyethylene glycol and combinations thereof.

28. The one-part foamable composition of claim 15, wherein said crosslinking agent, said acid and said base are each encapsulated in separate encapsulating materials selected from a wax, a melamine formaldehyde polymer, an acrylic, a gelatin, polyethylene oxide, polyethylene glycol and combinations thereof.

29. A method of making a foamed product using the foamable composition of claim 15, the method comprising releasing the crosslinking agent and the at least one of said acid and said base that were encapsulated to initiate (a) a crosslinking reaction between the crosslinking agent and the functionalized resin, and (b) a blowing reaction to generate a gas.

30. A foamed product produced by the process of claim 29.
